(19) United States
(12) Patent Application Publication
(10) Pub. No.: US 2007/0282763 A1
(43) Pub. Date: Dec. 6, 2007

(54) Digital menu board display system

(76) Inventor: Sung Ho Lee, San Diego, CA (US)

Correspondence Address: Samuel Lee, 10755 Scripps Poway Pkwy #415, San Diego, CA, 92131, US

(21) Appl. No.: 11/786,963

(22) Filed: Apr. 13, 2007

(30) Foreign Application Priority Data
Apr. 17, 2006 (KR) 10-2006-0034668

(51) Int. Cl. G06F 17/00

(52) U.S. Cl. 705/400

(57) ABSTRACT

A digital menu board display system including: a server system configured to receive, manage, and store information and advertisement data appropriate for each branch office system, the information including business type, location, scale, price of products, and other related information; and a plurality of branch office systems, each branch office system of the plurality of branch office systems comprising: a network modem for providing two-way communication with the server system, the network modem transmitting and receiving the information and advertisement data; a network hub for distributing the received information and advertisement data; and a plurality of display apparatus, each display apparatus of the plurality of display apparatus configured to decode, classify, and display the received information and advertisement data onto appropriate areas of the each display apparatus.

### BACKGROUND

The present invention relates to system and method for displaying digital information on menu boards.

Most fast food restaurants currently use menu board displays made of simple acrylic material to advertise their food. However, desires and needs of consumers change with a fast changing society. Accordingly, businesses need to adapt to the needs of consumers by providing effective and attention capturing advertisements that appeal to various tastes of consumers. Further, these advertisements need to reach as many consumers as possible at low cost.

Traditionally, there were two modes of advertising: an indoor advertising mode and an outdoor advertising mode. An example outdoor advertisement includes a sign board placed outside of the building. However, the drawback of the traditional sign board advertising mode is that the display on the sign board is fixed and thus cannot be easily modified according to the changing tastes of the consumers.

To address some of the above-described problems, several conventional advertisement display systems have been proposed. FIG. 1 is a block diagram showing one example of a conventional advertisement display system 100, which includes a server 110, a communication network 120, a modem 130, a client PC 140, and a plurality of display apparatus 150, 152, 154. However, advertisement display systems configured similar to the system 100 have shortcomings in that the entire system can crash or be brought down by a power failure or a computer (e.g., the server 110 or the client PC 140) failure.

### SUMMARY

Embodiments of the present invention include a digital menu board display systems to implement a server-client system in which a server can manage, process, and store information and advertisement data received from and transmitted to a plurality of branch office systems.

In one embodiment, a digital menu board display system includes: a server system configured to receive, manage, and store information and advertisement data appropriate for each branch office system, the information including business type, location, scale, price of products, and other related information; and a plurality of branch office systems, each branch office system of the plurality of branch office systems including: a network modem for providing two-way communication with the server system, the network modem transmitting and receiving the information and advertisement data; a network hub for distributing the received information and advertisement data; and a plurality of display apparatus, each display apparatus of the plurality of display apparatus configured to decode, classify, and display the received information and advertisement data onto appropriate areas of the each display apparatus.

In another embodiment, a digital menu board display system comprises: (a) a server system configured to receive, manage, and store information and advertisement data appropriate for each branch office system, the server system comprising: (1) advertisement storage configured to store information and advertisement data received from the each branch office system as well as to store information and advertisement data tailored and generated for the each branch office system; (2) an advertisement database configured to classify information and advertisement data stored in the advertisement storage according to the characteristic of the each branch office system and to manage the information and advertisement data; (3) a branch office information database configured to store and manage branch office information including business type, location, and size of a branch office; (4) a central management server configured to manage and control overall data storage and flow within the server system, the central management server also configured to transmit information and advertisement data selected by the each branch office system, to store the information and advertisement data requested by the each branch office system, and to store information and advertisement data generated by the server system; and (b) a plurality of branch office systems, each branch office system of the plurality of branch office systems comprising: (1) a network modem for providing two-way communication with the server system, the network modem transmitting and receiving the information and advertisement data; (2) a network hub for distributing the received information and advertisement data; and (3) a plurality of display apparatus, each display apparatus of the plurality of display apparatus configured to decode, classify, and display the received information and advertisement data onto appropriate areas of the each display apparatus.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be understood in part by studying the accompanying drawings, in which like reference numerals refer to like parts, and in which:

FIG. 1 is a block diagram showing one example of a conventional advertisement display system;

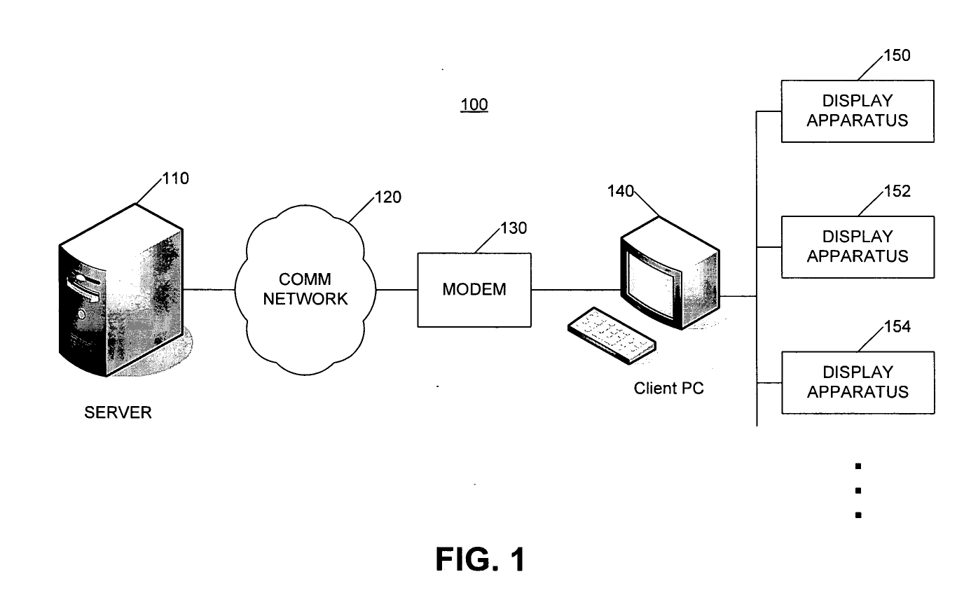

FIG. 2 is a block diagram showing one implementation of a digital menu board display system;

FIG. 3 is a detailed block diagram of the display control part in accordance with one embodiment of the present invention;

FIG. 4 is a block diagram of a digital menu board display system according to one embodiment of the present invention; and

FIG. 5 is a block diagram of a digital menu board display system according to another embodiment of the present invention.

### DETAILED DESCRIPTION

The following detailed description is directed to certain specific embodiments of the invention. However, the invention can be embodied in a multitude of different systems and methods. In this description, reference is made to the drawings wherein like parts are designated with like numerals throughout.

To overcome the above-mentioned problems with conventional advertisement display systems, various embodiments of the present invention utilize digital signal processing (DSP) in an embedded system to provide dynamic and interesting contents at desirous times for the user of the advertisement systems.

The advertisement display system enables the user to appropriately manage the advertising content and allows the user to tailor the advertising content to meet the strategic needs of the user. For example, when the demand for a particular product is low, tailoring the advertising content to stimulate the buying urge of the consumer can increase the demand for that particular product. In another example, within a department store, during a high customer traffic hour, the advertising content can be tailored to provide short and effective advertisement to promote high turnover of fast selling items.

In one implementation, the advertisement display system enables the main office to monitor and manage point of sale (POS) transactions and sales figures real-time. Further, the advertisement display system allows the main office to adjust sales products and prices according to the result of the monitored transactions and sale figures. In another implementation, the advertisement display system includes a diagnostic capability that constantly check the health status of the display apparatus located at each store. In a further implementation, the advertisement display system allows the display apparatus to be split into multiple windows so that the apparatus can display multiple advertisements including advertisements for items other than the owner/user.

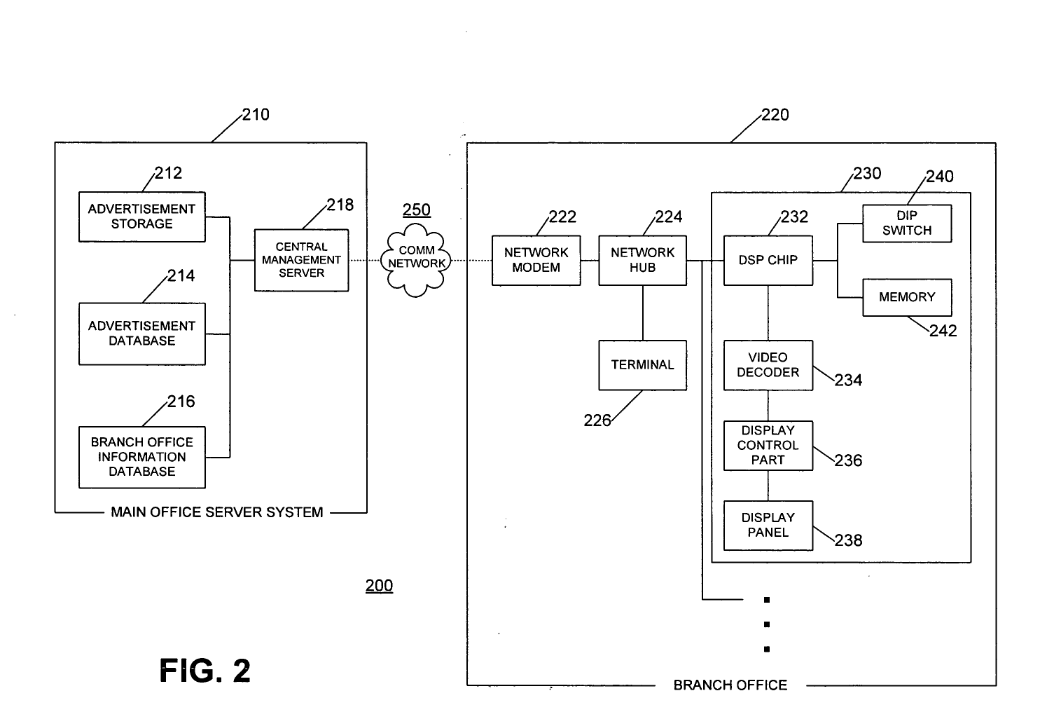

FIG. 2 is a block diagram showing one implementation of a digital menu board display system 200. In the illustrated implementation of FIG. 2, the digital menu board display system 200 includes a server system 210 and a branch office system 220 connected through a network to provide information and advertisement. In practice, the server system 210 is usually connected to a plurality of branch office systems.

The server system 210 includes advertisement storage 212, an advertisement database 214, a branch office information database 216, and a central management server 218. The branch office system 220 includes a network modem 222, a network hub 224, a terminal 226, and a display apparatus 230. The display apparatus 230 further includes a DSP (Digital Signal Processor) chip 232, a video decoder 234, a display control part 236, a display panel 238, a Dip Switch 240, and a memory 242 for storing data.

Referring to FIG. 2, the units of the server system 210 serve various functions according to the needs of the system 210. For example, the advertisement storage 212 is configured to store information and advertisement data received from each branch office system as well as to store information and advertisement data tailored and generated for each branch office system. The advertisement database 214 is configured to classify information and advertisement (i.e., data) stored in the advertisement storage 212 according to the characteristic of each branch office system and to manage those data. The branch office information database 216 is configured to store and manage branch office information such as business type, location, and size of the branch office. The branch office information database 216 is also enabled to provide different code for each branch office system. The central management server 218 is configured to manage and control the overall data storage and flow within the server system 210. The central management server 218 is also configured to transmit information and advertisement data selected by the branch office system, to store information and advertisement data requested by the branch office system, and to store the branch-office-requested information and advertisement data generated by the main office server system 210. The central management server 218 is further configured to provide authentication of each branch office system so that only the authorized personnel of the branch office system is able to access the storage and database of the main office server system 210. The central management server 218 connects to the branch office system 220 through a communication network 250, which may include Local Area Network (LAN), Wide Area Network (WAN), Integrated Services Digital Network (ISDN), and satellite communication network.

The units of the branch office system 220 serve various functions according to the needs of the equipment 220. For example, the network modem 222 transmits information and advertisement data received from the main office server system 210 to the network hub 224. The network modem 222 also receives data from the network hub 224 and transmits that data to the central management server 218 in the main office server system 210 through the communication network 250. The network hub 224, which, in one implementation, includes 4 to 24 ports, transmits information and advertisement data to each display apparatus 230 of a plurality of apparatus.

Moreover, the network hub 224 is configured to connect to the terminal 226, such as personal/notebook computer, to allow the terminal 226 to manage and update the information (e.g., image, price, video of a new product, etc.) displayed on the display apparatus 230. This configuration allows the terminal 226 to manage and update (i.e., local update) the displayed information in real-time. This configuration further allows the terminal 226 to prepare and transmit the needed information and advertisement data from the branch office system 220 to the main office server system 210 so that the main office server system 210 can perform faster remote update of the display apparatus 230 in the branch office system 220.

As mentioned above, the display apparatus 230 includes the DSP chip 232, the video decoder 234, the display control part 236, the display panel 238, the Dip Switch 240, and the memory 242 for storing data. The DSP chip 232 is configured to control the operation of the display apparatus 230 using an operating system such as Linux to digitally process the received information and advertisement data. The DSP chip 232 classifies the received information and advertisement data for appropriate decoding and display. For example, video advertisement data can be decoded into an MPEG-4 format for a high quality DVD player while the text or image advertisement data can be decoded into a JPEG format for an appropriately high quality text or picture.

The Dip Switch 240 coupled to the DSP chip 232 allows each display apparatus 230 to be identified with a unique Internet Protocol (IP) address so that the main office server system 210 can control and manage the display apparatus 230 making it possible for the main office server system 210 to check and confirm status of each display apparatus 230 in real-time.

The memory 242 is configured to store information and advertisement data so that the data once displayed on the display apparatus 230 does not have to be retransmitted from the main office server system 210 to be displayed on the display apparatus 230 again.

The video decoder 234 is configured to receive and convert data from the DSP chip 232 to a format appropriate for displaying the data on the display apparatus 230. In one implementation, the data received from the DSP chip 232 may be in a compressed format such as MPEG-4, and the video decoder 234 decodes the MPEG-4 data into an appropriate format for display on the display apparatus 230.

The display control part 236 is configured to control the output of information and advertisement data decoded by the video decoder 234 and displayed by the display apparatus 230. The display control part 236 also manages the layout of the information and advertisement data on the display panel 238 using metadata, video data, and/or other related text/subtitle messages.

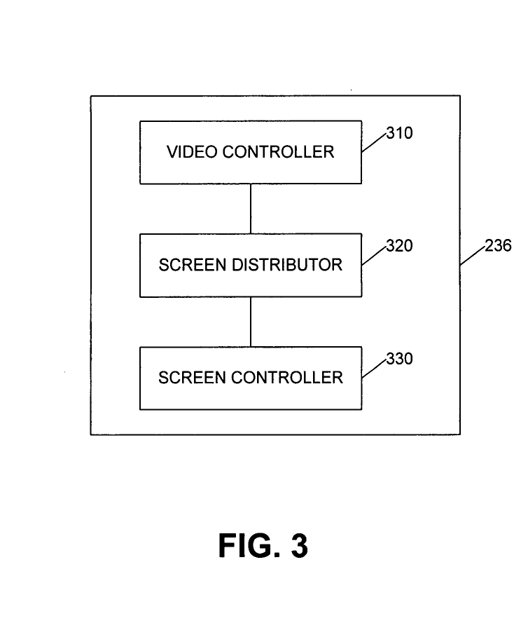

FIG. 3 is a detailed block diagram of the display control part 236 in accordance with one embodiment of the present invention. As illustrated in FIG. 3, the display control part 236 includes a video controller 310 configured to classify output data into text, image, and/or video; a screen distributor 320 configured to optimally distribute the classified text, image and/or video onto a display panel 238; and a screen controller 330 configured to control the power of the display apparatus 230. The screen controller 330 is also configured to manage the content of the advertisement, time of display, and the display position of the advertisement on the display panel 238. The display panel 238 can be configured with Organic Light Emitting Diodes (OLED), Liquid Crystal Display (LCD), Plasma Display Panel (PDP), or other similarly-configured elements or combination of elements.

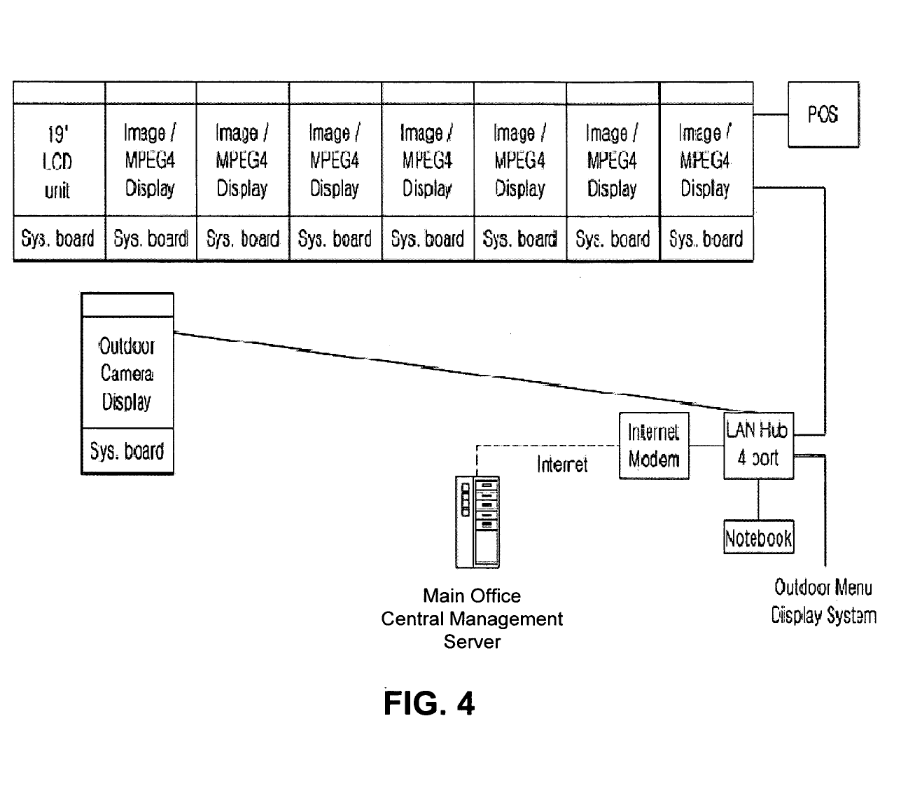

FIG. 4 is a block diagram of a digital menu board display system according to one embodiment of the present invention. In the illustrated embodiment of FIG. 4, the branch office receives information and advertisement data transmitted from the main office central management server through a communication network, such as the Internet, using an internet modem. The data can be distributed by a LAN hub to various display systems including an outdoor menu display system, an outdoor camera display system, and an indoor menu display system. The LAN hub can be controlled by a personal computer (PC) such a notebook computer.

The branch office also links with a Point of Sale (POS) system, which may include Electronic Cash Register (ECR) and other related devices such as a computer. The POS system processes input data about sales at each branch office including name and price of the product, quantity of a specific product sold, and other related sales information. The POS system further processes the input data to determine which products to order and supply and which data to display on the branch office menu board display apparatus. For example, if the price of a product is changed at the POS system, the price of that product to be displayed can also be changed in real-time. Further, if the price a product is changed at the main office central management server, the price of that product to be displayed as well as the price recorded in the POS system can be changed real-time.

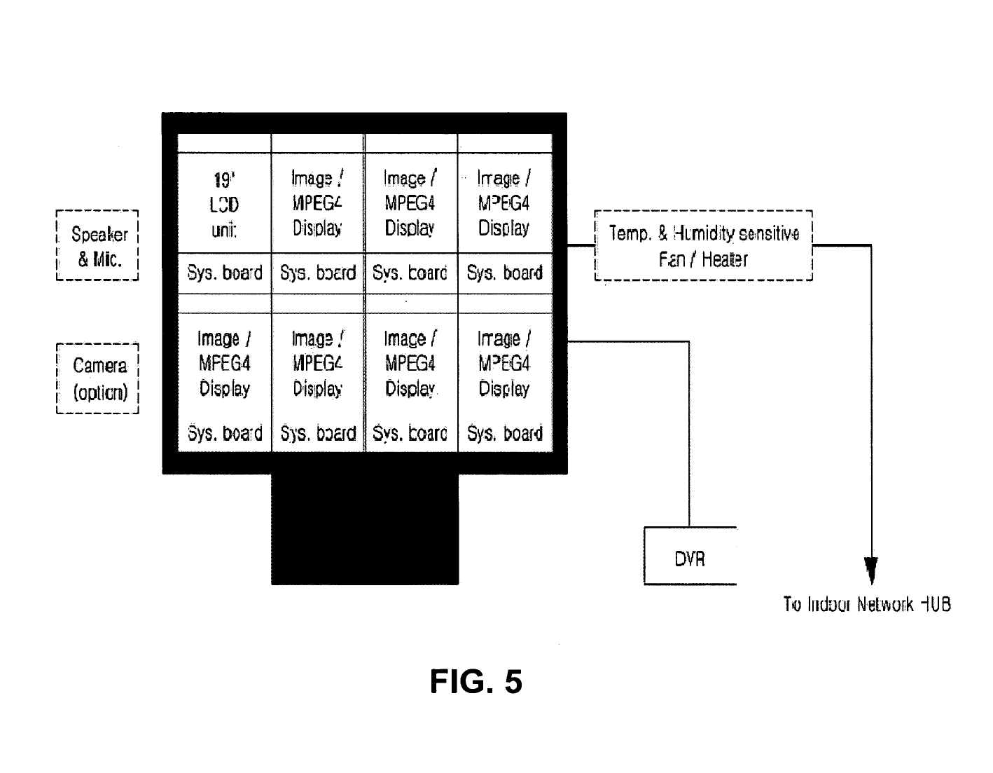

FIG. 5 is a block diagram of a digital menu board display system according to another embodiment of the present invention. In the illustrated embodiment of FIG. 5, the system is configured as an outdoor system including temperature and humidity controls to protect the system for a longer life. The illustrated system includes temperature and humidity sensors to automatically trigger the fan and heater to turn on and off. Thus, an outdoor system like the one shown in FIG. 5 can be configured to act as active advertisement as well as event publicity. The system can also receive input from a camera installed outside to react to any changes from the surrounding area and double as a security device.

As mentioned above, embodiments of the digital menu board display system as described above provide several advantages over the conventional system in that the embodiments of the present invention provide active and dynamic (e.g., real-time) advertisement on the menu board display. Since the customers are constantly viewing the display while waiting to order, the advertisement can reach more people for longer periods of time. The digital menu board display system is configured so that the display can be easily modified to suit the needs of a particular branch office. Moreover, since the menu board display system is configured to operate digitally, the system can provide Do-It-Yourself (DIY) ordering, Internet service/ordering, security camera functions, and other additional publicity and advertisement. Further, since the digital menu board display system is configured as a distributed system, the system is substantially resistant to fatal errors or faults caused by virus or shutdown of portions of the system.

The present invention is not limited to the above embodiment. As the present invention may be embodied in several forms without departing from the spirit or essential characteristics thereof, it should also be understood that the above-described examples are not limited by any of the details of the foregoing description, unless otherwise specified, but rather should be constructed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A digital menu board display system comprising:
a server system configured to receive, manage, and store information and advertisement data appropriate for each branch office system, said information including business type, location, scale, price of products, and other related information; and
a plurality of branch office systems, each branch office system of said plurality of branch office systems comprising:
a network modem for providing two-way communication with said server system, said network modem transmitting and receiving said information and advertisement data;
a network hub for distributing said received information and advertisement data; and
a plurality of display apparatus, each display apparatus of said plurality of display apparatus configured to decode, classify, and display said received information and advertisement data onto appropriate areas of said each display apparatus.

2. The digital menu board system of claim 1, wherein said server system further comprises
advertisement storage configured to store information and advertisement data received from said each branch office system as well as to store information and advertisement data tailored and generated for said each branch office system.

3. The digital menu board system of claim 2, wherein said server system further comprises
an advertisement database configured to classify information and advertisement data stored in said advertisement storage according to the characteristic of said each branch office system and to manage said information and advertisement data.

4. The digital menu board system of claim 1, wherein said server system further comprises
a branch office information database configured to store and manage branch office information including business type, location, and size of a branch office.

5. The digital menu board system of claim 4, wherein said branch office information database is enabled to provide different code for each branch office system.

6. The digital menu board system of claim 1, wherein said server system further comprises
a central management server configured to manage and control overall data storage and flow within said server system, said central management server also configured to transmit information and advertisement data selected by said each branch office system, to store said information and advertisement data requested by said each branch office system, and to store information and advertisement data generated by said server system.

7. The digital menu board system of claim 1, wherein said each branch office system further comprises
a computer terminal configured to manage and update information displayed on said each display apparatus.

8. The digital menu board system of claim 7, wherein said information comprises:
an image, a price, and a video of a new product.

9. The digital menu board system of claim 1, wherein said each display apparatus further comprises
a DSP chip configured to control the operation of said each display apparatus using an operating system to digitally process said information and advertisement data, said DSP chip operating to classify said information and advertisement data for appropriate decoding and display.

10. The digital menu board system of claim 9, wherein said information and advertisement data is
a video data of an MPEG-4 format used for a high quality DVD player.

11. The digital menu board system of claim 9, wherein said information and advertisement data is
a text or image data of a JPEG format used for a high quality text or picture.

12. The digital menu board system of claim 9, wherein said each display apparatus further comprises
a Dip switch coupled to said DSP chip, said Dip switch configured to allow said each display apparatus to be identified with a unique Internet Protocol (IP) address so that said server system controls and manages said each display apparatus, said Dip switch allowing said server system to check and confirm status of said each display apparatus in real-time.

13. The digital menu board system of claim 9, wherein said each display apparatus further comprises
a video decoder configured to receive and convert data from said DSP chip to a format appropriate for displaying the data on said each display apparatus.

14. The digital menu board system of claim 13, wherein said each display apparatus further comprises:
a display panel; and
a display control part configured to control the output of information and advertisement data decoded by said video decoder and displayed by said each display apparatus, said display control part operating to manage the layout of said information and advertisement data on said display panel using at least one of metadata, video data, and other related text/subtitle messages.

15. The digital menu board system of claim 14, wherein said display panel is configured with Organic Light Emitting Diodes (OLED).

16. The digital menu board system of claim 14, wherein said display control part further comprises
a video controller configured to classify output data into at least one of text, image, and video.

17. The digital menu board system of claim 16, wherein said display control part further comprises
a screen distributor configured to optimally distribute said at least one of text, image and video classified by said video controller onto said display panel.

18. The digital menu board system of claim 14, wherein said display control part further comprises
a screen controller configured to control power of said each display apparatus, said screen controller operating to manage content of advertisement, time of display, and display position of advertisement on said display panel.

19. A digital menu board display system comprising:
(a) a server system configured to receive, manage, and store information and advertisement data appropriate for each branch office system, said server system comprising:
(1) advertisement storage configured to store information and advertisement data received from said each branch office system as well as to store information and advertisement data tailored and generated for said each branch office system;
(2) an advertisement database configured to classify information and advertisement data stored in said advertisement storage according to the characteristic of said each branch office system and to manage said information and advertisement data;
(3) a branch office information database configured to store and manage branch office information including business type, location, and size of a branch office;
(4) a central management server configured to manage and control overall data storage and flow within said server system, said central management server also configured to transmit information and advertisement data selected by said each branch office system, to store said information and advertisement data requested by said each branch office system, and to store information and advertisement data generated by said server system; and
(b) a plurality of branch office systems, each branch office system of said plurality of branch office systems comprising:
(1) a network modem for providing two-way communication with said server system, said network modem transmitting and receiving said information and advertisement data;
(2) a network hub for distributing said received information and advertisement data; and
(3) a plurality of display apparatus, each display apparatus of said plurality of display apparatus configured to decode, classify, and display said received information and advertisement data onto appropriate areas of said each display apparatus.
